(19) United States
(12) Patent Application Publication
(10) Pub. No.: US 2012/0104754 A1
(43) Pub. Date: May 3, 2012

(54) WIND TURBINE WITH LVRT CAPABILITIES

(76) Inventors: Georg Rudolf, Bliestorf (DE); Karl-Friedrich Stapelfeldt, Lubeck (DE)

(21) Appl. No.: 13/146,900

(22) PCT Filed: Apr. 30, 2009
(86) PCT No.: PCT/EP09/03158

§ 371 Date: Jan. 13, 2012

Related U.S. Application Data
(60) Provisional application No. 61/148,777, filed on Jan. 30, 2009.

(51) Int. Cl. H02P 9/10

(52) U.S. Cl. 290/44

(57) ABSTRACT

Systems and methods (“utility”) for providing Low Voltage Ride Through (LVRT) capabilities for wind turbines are disclosed. The utility includes a directly connected synchronous generator (214) that is designed to have a high dynamic pull-out torque. To remain connected to the power grid (224) during low voltage events, the utility boosts the excitation current applied to the rotor of the synchronous generator (214). Further, the utility may include a torque regulator in the form of d torque-regulating gearbox (210), which in turn includes adjustable guide vanes (624) that may be positioned to reduce the amount of mechanical torque applied to the rotor shaft of the synchronous generator (224) during low voltage events. Additionally, the utility may also include a braking system (206) and a pitch control system (234) to limit the acceleration of the wind rotor (202) shaft during low voltage events.

### CROSS-REFERENCE TO RELATED APPLICATIONS

This patent application claims priority under 35 U.S.C. §119(e) to pending U.S. Provisional Patent Application Ser. No. 61/148,777, that is entitled “LOW VOLTAGE RIDE THROUGH FOR WIND TURBINES,” that was filed on Jan. 30, 2009, and the entire disclosure of which is hereby incorporated by reference in its entirety herein.

### FIELD OF THE INVENTION

The present invention generally relates to the field of wind turbines and, more particularly, to configuring/operating a wind turbine to remain connected to a power grid during a low voltage ride through condition.

### BACKGROUND

The application of wind-powered generating systems in the past has been on a small scale when compared to the total generating capacity of an electrical power grid. A term that is often used to describe the relative quantity of wind-generated power is “penetration.” Penetration is the ratio of wind-generated power to the total available generated power for a power grid. Previously, even in those locations where wind-generated power is the highest, the penetration levels were in the range of a few percent. While this is a relatively small amount of power, and the rules that govern the operation of the wind turbines reflect this small penetration, it is clear that the penetration is increasing and therefore the operating rules for the wind turbines are and will be changing. For example, one operating principle that is being revised is the required amount of grid stability support that must be provided by wind turbines. As can be appreciated, as the penetration of wind turbines increases, the expectation that they contribute to the stability of powers grids becomes greater.

Power utilities today face an ever-growing demand for higher quality, reliable power and increased transmission capacity. A key to increasing reliability and capacity is ensuring that grid voltage is properly regulated. This helps prevent service disruptions, damage to electrical service equipment, generating plants, and other components of the power grid and can help maximize transmission capacity. In order to reliably supply power to the power grid, wind turbine generators (as well as other types of generators) must conform to power grid interconnection standards that define requirements imposed on power suppliers and large power consumers. One such standard is a “low voltage ride through” (LVRT) requirement which typically requires that a power generation unit remain connected and synchronized to the power grid when the voltage at the terminals of the generation unit fall to prescribed levels for prescribed periods of time (e.g., 15% of rated level for 0.5 seconds, or the like).

The LVRT requirement has been addressed in steam and gas turbine generator plants through use of vital electrical buses that are powered by DC power sources and by auxiliary buses connected to the generators. Since the input power (i.e., steam or gas) can be closely regulated, these types of generators are typically more resistant to voltage fluctuations than are wind turbine generators, which are dependent upon highly variable wind speeds to supply the mechanical energy. In the past, wind turbine generators have been allowed to trip offline during a low voltage event to protect them from harm. However, for reasons noted above, it is becoming more important that the wind turbines include LVRT capabilities to support the power grid during these undesirable voltage fluctuations.

### SUMMARY

The present invention at least generally relates to configuring and/or operating a wind turbine to remain connected to a power grid during a low voltage ride through condition. The present invention may be utilized by a wind turbine that is being operated as a stand-alone unit, but also may be utilized by one or more wind turbines within a wind farm/park (e.g., where a plurality of wind turbines are interconnected or at least may be interconnected with a power grid through a point of common coupling). Regardless of its manner of implementation, a wind turbine according to the present invention may include a turbine rotor (e.g., with one or more associated blades), a synchronous generator, a torque regulator or “TR” in a drive train between the turbine rotor and synchronous generator (e.g., one such TR being a torque-regulating gearbox (TRG)), and possibly other components. Embodiments of the invention may include configuring and operating the above-noted and other components to facilitate fault voltage ride through functionality (e.g., low voltage ride through functionality) for the wind turbine. Various aspects of the present invention will now be described. Although each of the following aspects may relate or be applicable to the foregoing, the content of this introduction is not a requirement for any of these aspects unless otherwise noted.

A first aspect of the present invention is embodied by an automated method that allows a wind turbine to remain electrically connected with a power grid during a low voltage event. The wind turbine may include a synchronous generator coupled to the power grid and to a turbine rotor through a torque regulator (e.g., a TRG). The automated method may include detecting a low voltage event. Further, the automated method may include boosting a rotor current of the synchronous generator to provide reactive power to the power grid during the low voltage event, wherein the boosting of rotor current is initiated in response to detecting the low voltage event.

A number of feature refinements and additional features are applicable to the first aspect of the present invention. These feature refinements and additional features may be used individually or in any combination. The following discussion is separately applicable to the first aspect, up to the start of the discussion of a second aspect of the present invention.

In an embodiment of the first aspect, the automated method may include adjusting operation of the torque regulator, for instance to change the amount of torque that is transferred between the turbine rotor and the synchronous generator (e.g., to reduce the torque applied to a shaft of the synchronous generator in response to the detection of the low voltage event). The torque regulator may be of any appropriate size, shape, configuration, and/or type. Any appropriate way of regulating the torque transfer from the turbine rotor to the synchronous generator may be utilized (e.g., electrically, hydraulically).

In an embodiment of the first aspect, the automated method may include adjusting a torque conversion characteristic of a torque regulator in the form of a TRG (e.g., to reduce a mechanical torque applied to a shaft of the synchronous generator), wherein the adjustment of the torque conversion characteristic is initiated in response to the detection of the low voltage event. The TRG may include a hydraulic circuit, and the automated method may include reducing a mass flow of hydraulic fluid through the hydraulic circuit (e.g., to modify the operational characteristics of the TRG), wherein the reduction of mass flow is initiated in response to the detection of the low voltage event. Further, the TRG may include a plurality of guide vanes disposed in a guide vane housing, and the automated method may include adjusting a position of the guide vanes to, for example, modify the mass flow of hydraulic fluid through the hydraulic circuit, wherein the guide vane adjustment is initiated in response to the detection of the low voltage event. The automated method of the first aspect may also include adjusting an amount of energy absorbed by the TRG in response to the detection of the low voltage event, which may be advantageous for maintaining the electrical connection between the wind turbine and the power grid during the low voltage event.

In an embodiment of the first aspect, the automated method may include initiating a reduction in a rotational speed of the turbine rotor (e.g., in response to the detection of the low voltage event). The rotational speed of the turbine rotor may be reduced in any appropriate manner (e.g., activating or applying one or more brakes or braking devices of any appropriate type, changing the pitch of the turbine rotor blades, or both). The amount that the rotational speed of the turbine rotor is reduced may be undertaken on any appropriate basis.

In an embodiment of the first aspect, the automated method may include activating or applying at least one brake associated with a drive train that extends between the turbine rotor and the synchronous generator (e.g., to reduce a rotational speed of the turbine rotor), wherein such braking may be initiated in response to the detection of the low voltage event. As an example, the braking may be controlled so to be dependent upon and/or proportional to a voltage of the power grid (or on any other appropriate basis).

The automated method of the first aspect of the present invention may also include adjusting a blade pitch of a plurality of blades of the wind turbine in response to the detection of the low voltage event (e.g., to reduce a rotational speed of the turbine rotor). The automated method may also include isolating one or more electrical peripherals associated with the wind turbine from the power grid during the low voltage event, wherein this isolation is initiated in response to the detection of the low voltage event. In this regard, the potential harm caused by the low voltage event to the one or more electrical peripherals may be significantly reduced. The automated method may further include providing an uninterruptable power supply (UPS) operative to provide power to one or more components of the wind turbine during the low voltage event. As an example, the UPS may include a battery power supply, although one or more energy storage devices of any appropriate type may be utilized.

A second aspect of the present invention is embodied by a wind turbine that may remain electrically connected to a power grid during a low voltage event. The wind turbine may include a turbine rotor, a torque regulator (e.g., a TRG), and a synchronous generator, where the turbine rotor includes a plurality of turbine blades, and where the torque regulator is located between the turbine rotor and the synchronous generator (e.g., such that the synchronous generator is coupled to the turbine rotor through the torque regulator; such that the torque regulator is in a drive train that extends between the turbine rotor and the synchronous generator). Further, the wind turbine may include a controller that is operative to detect an occurrence of a low voltage event and, in response to detecting such a low voltage event, to cause a boost in a rotor current of the synchronous generator to provide reactive power to the power grid during the low voltage event.

A number of feature refinements and additional features are applicable to the second aspect of the present invention. These feature refinements and additional features may be used individually or in any combination. The following discussion is separately applicable to the second aspect, up to the start of the discussion of a third aspect of the present invention.

The torque regulator may be of any appropriate size, shape, configuration, and/or type. Any appropriate way of regulating the torque transfer from the turbine rotor to the synchronous generator may be utilized (e.g., electrically, hydraulically). In an embodiment of the second aspect where the torque regulator is in the form of a TRG, the TRG of the wind turbine may include a plurality of guide vanes operative to modify a torque conversion between the turbine rotor and the synchronous generator. Further, the controller may be operative to adjust a position of the plurality of guide vanes in response to the low voltage event to reduce a mechanical torque applied to the synchronous generator. For example, the TRG may include a hydraulic circuit, and the plurality of guide vanes may be disposed in the hydraulic circuit. In an embodiment of the second aspect, the controller may be operative to adjust an amount of energy absorbed by the TRG, which may be advantageous for maintaining the electrical connection between the wind turbine and the power grid during the low voltage event.

One or more brakes or braking devices of any appropriate type may be incorporated in any appropriate manner in a drive train that extends between the turbine rotor and synchronous generator (e.g., to reduce the rotational speed of the turbine rotor on any appropriate basis). In an embodiment of the second aspect, the wind turbine may include a brake associated with a shaft disposed between the turbine rotor and the torque regulator. In any case, the controller may be operative to activate or apply at least one brake in response to the detection of the low voltage event (e.g., to reduce a rotational speed of the turbine rotor). As an example, the controller may be operative to selectively activate or apply at least one brake dependent upon and/or proportional to a voltage of the power grid (or on any other appropriate basis).

The controller of the wind turbine of the second aspect of the present invention may also be operative to adjust a blade pitch of the plurality of blades of the wind turbine in response to the low voltage event (e.g., to reduce a rotational speed of the turbine rotor). The wind turbine may also include one or more electrical peripherals (e.g., a yaw drive, a hydraulic pump, an electric motor, or the like) associated with the wind turbine, and the controller may be operative to isolate the One or more electrical peripherals from the power grid during the low voltage event. In this regard, the potential harm caused by the low voltage event to the one or more electrical peripherals may be significantly reduced. The wind turbine may further include an uninterruptable power supply (UPS) operative to provide power to one or more components of the wind turbine during the low voltage event. As an example, the UPS may include a battery power supply, although one or more energy storage devices of any appropriate type may be utilized. Further, the controller may be further operative to determine that a voltage of the power grid has returned to a predetermined level following the low voltage event, and to resume normal operation of the wind turbine.

A third aspect of the present invention is embodied by an automated method that allows a wind turbine to remain electrically connected with a power grid during a low voltage event. The wind turbine may include a synchronous generator coupled to the power grid and to a turbine rotor through a torque regulator (e.g., a TRG). The automated method may include detecting a low voltage event, and in response: 1) boosting a rotor current of the synchronous generator (e.g., to provide reactive power to the power grid during the low voltage event); 2) adjusting a torque conversion characteristic of the torque regulator (e.g., to reduce a mechanical torque applied to a shaft of the synchronous generator); 3) adjusting a blade pitch of a plurality of blades of the wind turbine (e.g., to reduce a rotational speed of the turbine rotor); 4) activating or applying at least one brake associated with a drive train that extends disposed between the turbine rotor and the synchronous generator (e.g., to reduce a rotational speed of the turbine rotor); 5) isolating one or more electrical peripherals associated with the wind turbine from the power grid; and 6) providing an uninterruptable power supply (UPS) (e.g., a battery power supply, or more generally one or more energy storage devices of any appropriate type) operative to provide power to one or more components of the wind turbine during the low voltage event. Additionally, the automated method may include determining that a voltage of the power grid has returned to a predetermined level following the low voltage event, and resuming normal operation of the wind turbine.

A number of feature refinements and additional features are applicable to the third aspect of the present invention. These feature refinements and additional features may be used individually or in any combination. The following discussion is separately applicable to the third aspect, up to the start of the discussion of a fourth aspect of the present invention.

In an embodiment of the third aspect, the torque regulator is in the form of a TRG. The TRG may include a hydraulic circuit, and the adjustment of a torque conversion characteristic may include reducing a mass flow of hydraulic fluid through the hydraulic circuit to modify the operational characteristics of the TRG. Further, the TRG may include a plurality of guide vanes disposed in a guide vane housing, and the adjustment of a torque conversion characteristic may include adjusting a position of the guide vanes to, for example, modify the mass flow of hydraulic fluid through the hydraulic circuit. In an embodiment of the third aspect, the adjustment of a torque conversion characteristic may also include adjusting an amount of energy absorbed by the TRG, which may be advantageous for maintaining the electrical connection between the wind turbine and the power grid during the low voltage event.

A fourth aspect of the present invention is embodied by an automated method that allows a wind turbine to remain electrically connected with a power grid during a low voltage event. The wind turbine associated with this embodiment may include a synchronous generator coupled to the power grid and to a turbine rotor through a torque regulator (e.g., a torque-regulating gearbox (TRG)). The automated method may include detecting a low voltage event. The automated method may also include initiating a first action in response to the detection of a low voltage event, wherein the first action includes executing at least one step selected from the group consisting of: a) boosting a rotor current of the synchronous generator (e.g., to provide reactive power to the power grid during the low voltage event); and b) adjusting a torque conversion characteristic of the torque regulator (e.g., to reduce a mechanical torque applied to a shaft of the synchronous generator). The automated method may also include initiating a second action in response to the detection of a low voltage event, wherein the second action includes executing at least one step selected from the group consisting of: a) activating or applying at least one brake associated with a drive train that extends between the turbine rotor and the synchronous generator (e.g., to reduce a rotational speed of the turbine rotor); and b) adjusting a blade pitch of a plurality of blades of the wind turbine (e.g., to reduce a rotational speed of the turbine rotor).

A fifth aspect of the present invention is embodied by an automated method that allows a wind turbine to remain electrically connected with a power grid during a low voltage event. The wind turbine associated with this embodiment may include a synchronous generator coupled to the power grid and to a turbine rotor through a torque regulator (e.g., a torque-regulating gearbox (TRG)). The automated method may include detecting a low voltage event. The automated method may also include adjusting operation of the torque regulator, wherein the operational adjustment is initiated in response to the detection of the low voltage event.

A number of feature refinements and additional features are applicable to the fifth aspect of the present invention. These feature refinements and additional features may be used individually or in any combination. The following discussion is separately applicable to the fifth aspect, up to the start of the discussion of a sixth aspect of the present invention.

In an embodiment of the fifth aspect, the operational adjustment includes adjusting a torque conversion characteristic of the torque regulator. For example, the operational adjustment may include reducing a mechanical torque applied to a shaft of the synchronous generator. Additionally, in an embodiment of the fifth aspect where the torque regulator is in the form of a TRG, the TRG may include a hydraulic circuit, and the operational adjustment may include reducing a mass flow of hydraulic fluid through the hydraulic circuit to modify the operational characteristics of the TRG. Further, the TRG may include a plurality of guide vanes disposed in a guide vane housing, and the operational adjustment may include adjusting a position of the guide vanes to, for example, modify a mass flow of hydraulic fluid through the hydraulic circuit. In an embodiment of the fifth aspect, the automated method may also include adjusting an amount of energy absorbed by the TRG, which may be advantageous for maintaining the electrical connection between the wind turbine and the power grid during the low voltage event.

In an embodiment of the fifth aspect, the automated method may include activating or applying at least one brake associated with a drive train that extends between the turbine rotor and the synchronous generator (e.g., to reduce a rotational speed of the turbine rotor) in response to the detection of the low voltage event. As an example, the braking may be controlled so as to be dependent upon and/or proportional to a voltage of the power grid (or on any other appropriate basis). Further, the automated method may include boosting a rotor current of the synchronous generator to provide reactive power to the power grid during the low voltage event, wherein the boosting of rotor current is initiated in response to detecting the low voltage event.

The automated method of the fifth aspect of the present invention may also include adjusting a blade pitch of a plurality of blades of the wind turbine in response to the detection of the low voltage event (e.g., to reduce a rotational speed of the turbine rotor). The automated method may also include isolating one or more electrical peripherals associated with the wind turbine from the power grid during the low voltage event. In this regard, the potential harm caused by the low voltage event to the one or more electrical peripherals may be significantly reduced. The automated method may further include providing an uninterruptable power supply (UPS) operative to provide power to one or more components of the wind turbine during the low voltage event. As an example, the UPS may include a battery power supply, although one or more energy storage devices of any appropriate type may be utilized.

A sixth aspect of the present invention is embodied by a wind turbine that may remain electrically connected to a power grid during a low voltage event. The wind turbine may include a synchronous generator and a torque regulator coupled to the synchronous generator. The wind turbine may also include a turbine rotor coupled to the torque regulator, where the turbine rotor includes a plurality of turbine blades. Further, the wind turbine may include a controller that is operative to detect an occurrence of a low voltage event and, in response to detecting the low voltage event, to adjust operation of the torque regulator.

A number of feature refinements and additional features are applicable to the sixth aspect of the present invention. These feature refinements and additional features may be used individually or in any combination.

In an embodiment of the sixth aspect where the torque regulator is in the form of a TRG, the TRG of the wind turbine may include a plurality of guide vanes operative to modify a torque conversion between the turbine rotor and the synchronous generator. Further, the controller may be operative to adjust a position of the plurality of guide vanes in response to the low voltage event (e.g., to reduce a mechanical torque applied to the synchronous generator). For example, the TRG may include a hydraulic circuit, and the plurality of guide vanes may be disposed in the hydraulic circuit. In an embodiment of the second aspect, the controller may be operative to adjust an amount of energy absorbed by the TRG, which may be advantageous for maintaining the electrical connection between the wind turbine and the power grid during the low voltage event.

In an embodiment of the sixth aspect, the wind turbine may include at least one brake associated with a drive train that extends between the turbine rotor and the synchronous generator. Further, the controller may be operative to activate or apply at least one brake in response to the low voltage event (e.g., to reduce a rotational speed of the turbine rotor). As an example, the controller may be operative to selectively activate or apply the at least one brake dependent upon and/or proportional to a voltage of the power grid (or on any other appropriate basis). Further, the controller may be operative to cause a boost in a rotor current of the synchronous generator to provide reactive power to the power grid during the low voltage event.

The controller of the wind turbine of the sixth aspect of the present invention may also be operative to adjust a blade pitch of the plurality of blades of the wind turbine in response to the low voltage event (e.g., to reduce a rotational speed of the turbine rotor). The wind turbine may also include one or more electrical peripherals (e.g., a yaw drive, a hydraulic pump, an electric motor, or the like) associated with the wind turbine, and the controller may be operative to isolate the one or more electrical peripherals from the power grid during the low voltage event. In this regard, the potential harm caused by the low voltage event to the one or more electrical peripherals may be significantly reduced. The wind turbine may further include an uninterruptable power supply (UPS) operative to provide power to one or more components of the wind turbine during the low voltage event. As an example, the UPS may include a battery power supply, although one or more energy storage devices of any appropriate type may be utilized. Further, the controller may be further operative to determine that a voltage of the power grid has returned to a predetermined level following the low voltage event, and to resume normal operation of the wind turbine.

A number of feature refinements and additional features are separately applicable to each of above-noted aspects of the present invention. These feature refinements and additional features may be used individually or in any combination in relation to each of the above-noted aspects of the present invention. Any feature of any other various aspects of the present invention that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the singular (e.g., indicating that a wind turbine includes “a brake” alone does not mean that the wind turbine includes only a single brake). Moreover, any failure to use phrases such as “at least one” also does not limit the corresponding feature to the singular (e.g., indicating that a wind turbine includes “a brake” alone does not mean that the wind turbine includes only a single brake). Finally, use of the phrase “at least generally” or the like in relation to a particular feature encompasses the corresponding characteristic and insubstantial variations thereof (e.g., indicating that a part is at least generally cylindrical encompasses the part being cylindrical).

Any torque regulator or the torque-regulating function addressed in relation to the present invention may utilize one or more torque-regulating devices or a torque-regulating system of any appropriate size, shape, configuration, and/or type. Torque may be regulated or adjusted (e.g., to reduce the torque transmitted to a shaft of the synchronous generator) in any appropriate manner (e.g., electrically, hydraulically). In one embodiment, the torque regulator is in the form of a TRG. Such a TRG may include a combination of a hydraulic or hydrodynamic torque converter and a planetary gear system (e.g., a multi-stage, functionally interconnected revolving planetary gear system).

Any brake or braking function addressed in relation to the present invention, for purposes of reducing a rotational speed of the turbine rotor in response to a low voltage event, may utilize one or more brakes or braking devices (more generally, a braking system) of any appropriate size, shape, configuration, and/or type. Each such brake may be implemented in any appropriate manner in relation to a drive train that extends from the turbine rotor to the synchronous generator, for instance so as to be disposed between the turbine rotor and the torque regulator.

Unless otherwise noted herein, each of the various actions addressed herein and that may be initiated in response to the detection of a low voltage event may be initiated in any appropriate order, including where one or more actions are initiated sequentially, where one or more actions are initiated simultaneously, or any combination thereof. Moreover, once a determination has been made that the low voltage event has concluded (e.g., that a voltage of the power grid has returned to a predetermined level), normal operation of the wind turbine may be resumed.

The synchronous generator addressed herein may be configured to have a relatively low d-axis synchronous reactance (e.g., less than about 1.4 p.u.). As an example, the synchronous generator may be configured to have a relatively low sub-transient reactance (e.g., less than about 0.15 p.u.), and a relatively low d-axis open circuit transient time constant (e.g., less than about 3 p.u.). As can be appreciated, the term “p.u.” refers to “per-unit,” which is a commonly used system for describing various characteristics (e.g., power, voltage, current, and impedance) of power systems and components of power systems using normalized values.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a graph of voltage versus time that illustrates a representative fault voltage ride through requirements (both high and low) for a wind turbine.

FIG. 2 is a schematic diagram of one embodiment of a wind turbine that incorporates low voltage ride through utility.

FIG. 3A is a cross-sectional schematic representation of a torque regulating gearbox that may be used by the wind turbine of FIG. 2.

FIG. 3B is an exploded, perspective view of a hydrodynamic torque converter used by the torque regulating gearbox of FIG. 3A.

FIG. 3C is a plan view of adjustable guide vanes, used by the hydrodynamic torque converter of FIG. 3B, in a maximum open position.

FIG. 3D is a plan view of the adjustable guide vanes, used by the hydrodynamic torque converter of FIG. 3B, in a closed position.

FIG. 4 is a flow diagram of one embodiment of a low voltage ride through protocol for a wind FIG. 5 is a flow diagram of another embodiment a low voltage ride through protocol for a wind FIG. 6 is timing diagram that illustrates various waveforms associated with a wind turbine during a low voltage ride through condition.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope and spirit of the invention as defined by the claims.

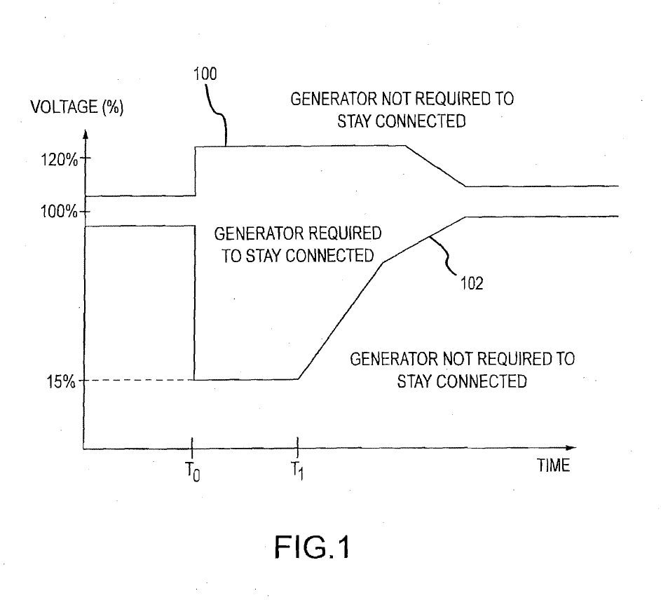

FIG. 1 is a graph of voltage versus time that illustrates an example of fault voltage ride through (FRT) requirements (including high voltage ride through (HVRT) and low voltage ride through (LVRT)) for a wind turbine. The FRT requirements are often measured at a point of interconnection between a wind farm and a power grid, rather than at an individual wind turbine. In this regard, even if the voltage at the point of interconnection dips very low (e.g., 0-15% of rated voltage), the voltage at the individual wind turbines may be somewhat higher. As shown, a line 100 indicates a HVRT requirement, while a line 102 indicates a LVRT requirement. More specifically, to meet the FRT requirements, a generator is required to remain connected to the power grid when the voltage of the power grid (at the point of interconnection) is between the HVRT line 100 and the LVRT line 102. The time period between time To and time Ti may be set by a utility company or other organization, and may have a value of 0.5 seconds, 0.625 seconds, or 1 second, for example. In this example, a wind turbine would be required to stay connected to the power grid if the voltage stays at or above 15%, and dips down to 15% for no longer than Ti minus To seconds. It should be appreciated that the VRT requirement shown in FIG. 1 is only one example of many FRT requirements that may be imposed by utility companies, standards organizations, countries, or the like. For example, generators may be required to stay connected to a power grid when the voltage at the point of interconnection dips down to 0% for a period of time.

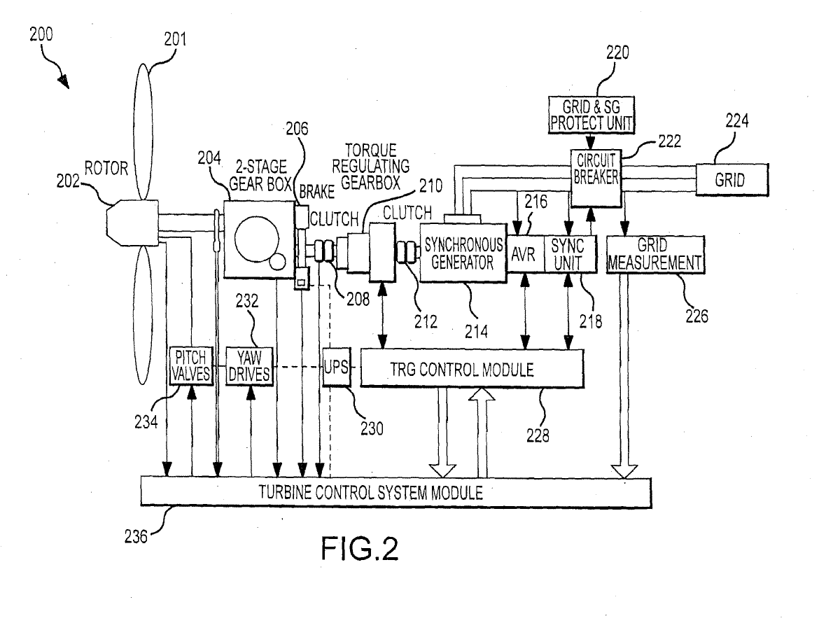

FIG. 2 is a schematic diagram of one embodiment of a wind turbine 200 that may be configured to provide low voltage ride through functionality. In operation, wind imparts energy to the blades 201 of a wind rotor 202, which in turn imparts a mechanical torque onto a shaft of a synchronous generator 214. The synchronous generator 214 is coupled directly to a power grid 224 to provide power to customers using the power grid 224. To adjust and control the rotational speed and torque applied to the synchronous generator 214, a fixed 2-stage mechanical gearbox 204 and a torque-regulating gearbox (TRG) 210 are disposed between the synchronous generator 214 and the wind rotor 202. Further, a turbine control system module 236 and a TRG control system module 228 may be provided to monitor and control the various functions of the wind turbine 200. Each of the various components of the wind turbine 200 is described in greater detail below.

In one embodiment, the synchronous generator 214 is a 2 Megawatt (MW), 4 pole self-excited synchronous generator that operates at a constant frequency of 1800 RPM for 60 Hz power systems (1500 RPM for 50 Hz power systems), although other synchronous generators may be utilized. An Automatic Voltage Regulator (AVR) 216 may be coupled to the synchronous generator 214 to provide voltage control, power factor control, synchronization functions, and the like. Advantageously, since the synchronous generator 214 is directly connected to the power grid 224, the need for complex power electronics to condition or transform the power may be eliminated. As can be appreciated, any suitable method may be used for the excitation of the synchronous generator 214. In one embodiment, the excitation system includes a pilot exciter, which may include a permanent magnet generator (PMG). Advantageously, this configuration may eliminate the requirement of an outside power supply to provide excitation, as well as eliminating the need for slip rings and/or brushes, which may reduce the maintenance requirements of the synchronous generator 214.

Because the synchronous generator 214 is directly coupled to the power grid 224, the dynamic behavior of the wind turbine 200 is partially determined by the rotational speed of the rotor shaft of the synchronous generator 214 and the frequency of the power grid 224 being absolutely fixed. That is, the energy captured from the wind must be processed between the wind rotor 202 and the synchronous generator 214. Therefore, one major design requirement is that the mechanical driving torque of the synchronous generator 214 should have a large enough safety margin with respect to the electrical pull-out torque. This requirement may be met by providing the synchronous generator 214 with suitable physical characteristics, by providing a torsional compliance and damping in the mechanical drive train, and by providing other techniques described herein.

As noted above, since the rotor speed of the synchronous generator 214 is fixed to the frequency of the power grid 224 and the wind speed is variable, the TRG 210 is provided to convert the torque and speed of the shaft of the wind rotor 202 to a form suitable for the synchronous generator 214. The TRG 210 may be of any appropriate configuration, for instance the TRG 210 may be in the form of a superimposition gearbox of any of a number of configurations. In one embodiment, the TRG 210 is a combination of a torque converter and a planetary gear system. A representative configuration for the TRG 210 is the WinDrive® available from Voith Turbo GmbH and Co. KG, having a place of business in Heidenheim, Germany. One or more features that may be used in relation to the TRG 210 are disclosed in U.S. Patent Application Publication Nos.: U.S. 2005/0235636, entitled “Hydrodynamic Converter,” and published on Oct. 27, 2005; U.S. 2005/0194787, entitled “Control System for a Wind Power Plant With Hydrodynamic Gear,” and published on Sep. 8, 2005; and U.S. 2008/0197636, entitled “Variable-Speed Transmission for a Power-Generating,” and published on Aug. 21, 2008, the entire disclosure of these three published applications being incorporated by reference herein.

The TRG 210 may be characterized as being disposed in a drive train that extends between the wind rotor 202 and the synchronous generator 214 (e.g., the drive train transferring the rotation of the wind rotor 202 to the synchronous generator 214). Any appropriate type of torque regulator or torque-regulating device/system may be utilized in place of the TRG 210 (in which case the above-noted TRG control system module 228 may also be referred to as a “torque regulator control system module 228”). The torque regulator or torque-regulating device/system may be incorporated in any appropriate manner in relation to the drive train that extends between the wind rotor 202 and the synchronous generator 214 (e.g., at one or more locations). Any appropriate way of regulating the torque transfer between the wind rotor 202 and the synchronous generator 214 may be utilized (e.g., electrically, hydraulically).

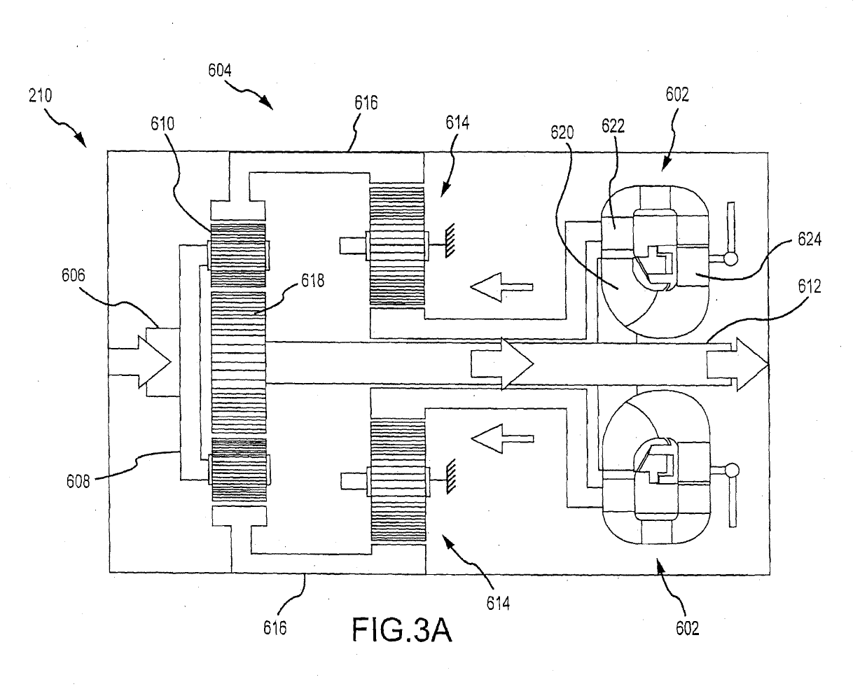

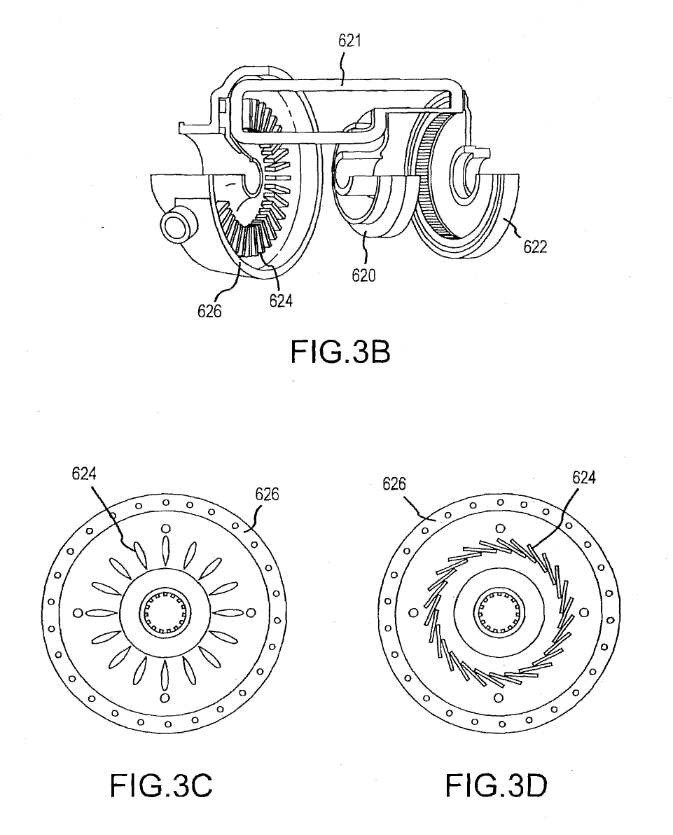

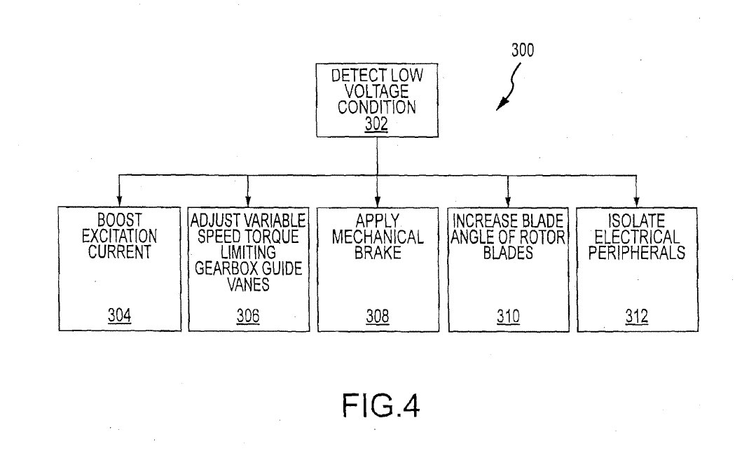

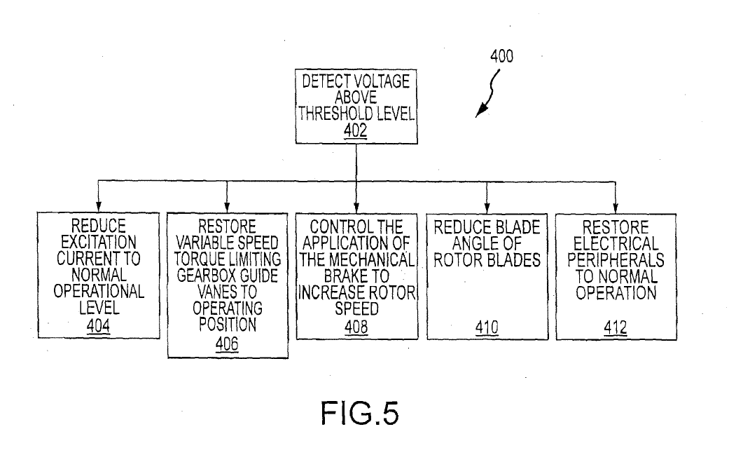

In one embodiment shown in FIGS. 3A-3D, the TRG 210 includes a combination of a hydraulic or hydrodynamic torque converter 602, and a 2-stage functionally interconnected revolving planetary gear system 604 positioned between the 2-stage mechanical gearbox 204 and the synchronous generator 214. In the revolving planetary gear system 604, input power from an input shaft 606 (which is rotatably driven by rotation of the wind rotor 202) is supplied to a carrier 608 of the left stage of the revolving planetary gear system 604. A plurality of planetary gears 610 are rotatably mounted on the carrier 608. Any appropriate number of planetary gears 610 may be utilized. Simultaneously, a hydrodynamic circuit drives the outer annulus (ring) gear 616 via a control drive.

In most planetary gear systems, one of the three elements (i.e., planet gear carrier, ring gear, or sun gear) is fixed. In the TRG 210 however, all three elements of the left stage of the revolving planetary gear system 604 may rotate. Between the annulus gear 616 and the fluid-machine it may be necessary to adapt speed and direction of rotation by means of a fixed gear stage 614. The revolving planetary gear system 604 leads both power flows via a sun gear 618 to an output shaft 612 that connects to the synchronous generator 214. In the hydraulic circuits, control power is taken from the output shaft 612 with a pump wheel 620 of the hydrodynamic torque converter 602 and returned to the revolving planetary gear system 604 via a turbine wheel 622 of the hydrodynamic torque converter 602. Power flow in a variable speed gear unit can vary continuously by an interacting combination of the revolving planetary gear system 604 and the hydrodynamic torque converter 602.

The hydrodynamic torque converter 602 is provided with adjustable guide vanes 624 (incorporated by a guide vane housing 626) and can thus be used as an actuator or control variable for the power consumption of the pump wheel 620. The energy content of the fluid and torque generated by the turbine wheel 622 varies with changes in pump wheel 620 power consumption. Rotation of the turbine wheel 622 is at least in part dictated or otherwise controlled by the position of the guide vanes 624. FIG. 3C shows the guide vanes 624 in the maximum open position (which would allow the turbine wheel 622 to rotate at a maximum speed under current conditions). FIG. 3D shows the guide vanes 624 in the closed position.

Adjusting the position of the guide vanes 624 between the open position (FIG. 3C) and closed position (FIG. 3D) controls the rotational speed of the turbine wheel 622, as well as the energy “absorbed” by the hydrodynamic torque converter 602.

The heart of a hydrodynamic torque converter 602 is its hydraulic circuit; including the pump wheel 620, turbine wheel 622, and a guide wheel or guide vane housing 626 with adjustable guide vanes 624. These components are combined in a common housing that contains hydraulic oil or any other appropriate fluid of an appropriate viscosity. A flow path of hydraulic fluid in the common housing is shown schematically in FIG. 3B and is identified by reference numeral 621. The mechanical energy of the input shaft 606 is converted into hydraulic energy through the pump wheel 620. In the turbine wheel 622, the same hydraulic energy is converted back into mechanical energy and transmitted to the output shaft 612. The adjustable guide vanes 624 of the guide wheel 626 regulate the mass flow in the hydraulic circuit. When the guide vanes 624 are closed (i.e., low mass flow; FIG. 3D), the power transmission is at its minimum. When the guide vanes 624 are completely open (i.e., large mass flow; FIG. 3C), the power transmission is at its maximum. Because of the change in mass flow (due to the adjustable guide vanes 624), the speed of the turbine wheel 622 can be adjusted to match the various operating points of the synchronous generator 214.

In operation and referring now to both FIG. 2 and FIGS. 3A-3D, the TRG control system module 228 of the wind turbine 200 may control the positioning of the guide vanes 624 of the TRG 210 so that the rotational speed and torque of the rotor shaft of the synchronous generator 214 is suitably controlled. In this regard, the TRG control system module 228 may communicate with the turbine control system module 236 to achieve this function. The control system modules 228 and 236 may be physically or logically isolated, or may be combined into a single unit. Further, the control system modules 228 and 236 may be implemented in hardware, software, a combination thereof, or in any appropriate manner. As an example, the control system modules 228 and 236 may be implemented in one or more “off-the-shelf” or customized microcontrollers.

Although one example of the TRG 210 is described above, again it should be appreciated that any suitable configuration (e.g., any torque-regulating device (TRD)) may be provided to convert the torque and speed of the shaft of the wind rotor 202 to a form suitable for the synchronous generator 214. As an example, a TRD that includes electrical mechanisms (as opposed to hydraulic) to regulate the torque and/or speed of the shaft of the wind rotor 202 may be used.

The wind turbine 200 of FIG. 2 again includes a wind rotor 202 that in turn includes a plurality of rotor blades 201 (e.g., three rotor blades) that may be designed for optimum aerodynamic flow and energy transfer. Any appropriate number of rotor blades 201 may be utilized. Further, the wind rotor 202 may include a pitch control system that is operable to adjust the angle of the rotor blades 201 in a desired/required manner. To achieve this functionality, the wind rotor 202 may include a hydraulic pitch control system that includes pitch valves 234 that are controllable by the turbine control system module 236. The position or pitch of the rotor blades 201 could be simultaneously or collectively adjusted, or could be independently adjusted.

In addition to pitch control, the wind turbine 200 of FIG. 2 may also include controllable yaw drives 232 that are operable to adjust the direction that the wind turbine 200 faces (specifically the direction

that the wind rotor 202 faces). For example, the turbine control system module 236 may control the yaw drives 232 to rotate the wind rotor 202 and its rotor blades 201 to face into the direction of the wind, such that the efficiency of the wind turbine 200 may be optimized.

The wind turbine 200 may also include an uninterruptable power supply (UPS) 230. The UPS 230 may be coupled to various components (e.g., the pitch valves 234, the control system modules 228 and 236, and the like) and functions to provide power to the components, especially when a main source of power is not available. The UPS 230 may include any type of power system, including one or more batteries, photovoltaic cells, capacitors, flywheels, and the like.

The wind turbine 200 may also include a controllable mechanical brake 206 coupled between the 2-stage gearbox 204 and the TRG 210. The brake 206 may be controlled by the turbine control system module 236 to reduce the rotational speed of the wind rotor 202. It should be appreciate that any suitable braking mechanism may be used, including but not limited to tip brakes, ailerons, spoilers, boundary layer devices, and the like. One or more brakes of any appropriate type may be included in the drive train between the wind rotor 202 and the synchronous generator 214, for instance so as to be disposed between the wind rotor 202 and the TRG 210. In addition, friction clutches 208 and 212 may be disposed in the mechanical drive train to limit the torque applied between components and to selectively couple and decouple the various shafts of the drive train components.

As can be appreciated, before the synchronous generator 214 is coupled directly to the power grid 224, certain conditions must be met. For example, the stator voltage of the synchronous generator 214 must substantially match the voltage of the power grid 224, and the frequency and phase of the voltages must match as well. To achieve this functionality, a synchronization unit 218, a grid measurement unit 226, and a circuit breaker 222 may be provided for the wind turbine 200. In operation, the synchronization unit 218 may communicate with the AVR 216 and the control system modules 236 and 228 to adjust the voltage characteristics of the synchronous generator 214 to match those of the power grid 224 as measured by the grid measurement unit 226. Once the voltage characteristics substantially match on both the generator side and the power grid side, the synchronization unit 218 may send a command to the circuit breaker 220 to close the circuit, thereby coupling the synchronous generator 214 to the power grid 224. The circuit breaker 222 may also be coupled to a grid and generator protection unit 220 that is operative to sense harmful conditions where it may be desirable to disconnect the wind turbine 200 from the power grid 224.

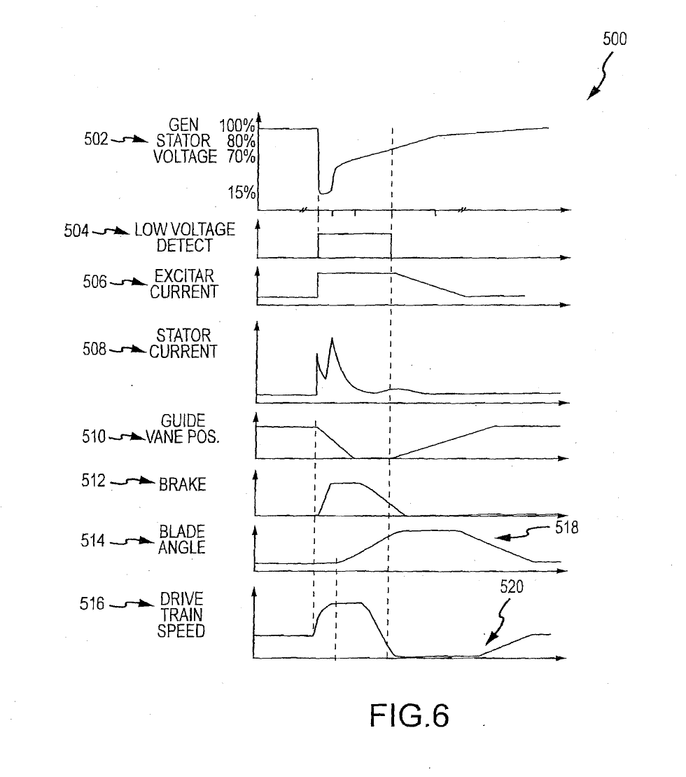

FIG. 4 is a flow diagram 300 of one embodiment of a process or protocol for low voltage ride through in the wind turbine 200. It should be appreciated that the steps described herein may be executed in various sequential orders, or concurrently. Further, some embodiments of an exemplary LVRT process may include a subset or all of the steps. In discussing the flow diagram 300, various components of the wind turbine 200 of FIGS. 2 and 3A-3D may be addressed. The functionality embodied by the flow diagram 300 may be implemented by the wind turbine 200 in any appropriate manner (e.g., utilizing one or both of the control system modules 236, 228)

Initially, the wind turbine 200 may detect a low voltage event condition (step 302). For example, the grid measurement unit 226 may sense the existence of a low voltage on the power grid 224, and then provide an indication to the turbine control system module 236. Such an indication may include asserting a “low voltage detect” signal. Once a low voltage condition has been detected, the wind turbine 200 may then use a variety of techniques that enable the synchronous generator 214 to remain coupled directly to the power grid 224 during the low voltage event.

Immediately after the low voltage event has been detected, the AVR 216 may be controlled to boost the excitation current applied to the rotor winding of the synchronous generator 214 (step 304). This has the effect of increasing the rotor field energy, which in turn supports the voltage at the stator of the synchronous generator 214 during the low voltage event by boosting the reactive power. By sustaining the stator voltage, the unbalance between the mechanical torque (from the wind) and the reduced electrical torque (from the grid 224) should be minimized.

As noted above, when a low voltage event occurs, there will be an unbalance between the mechanical torque and the electrical torque due to the rapid decrease of the voltage level at the stator of the synchronous generator 214. To further minimize this unbalance, the turbine control system module 236 and the TRG control system module 228 may operate to rapidly adjust the position of the guide vanes 624 of the TRG 210 to limit the mechanical torque increase applied to the shaft of the synchronous generator 214 (step 306).

As can be appreciated, by reducing the torque on the generator side of the TRG 210, the excess torque on the wind rotor 202 side will tend to accelerate the wind rotor 202. To limit the acceleration of the wind rotor 202, the turbine control system module 236 may apply mechanical brake 206 to the output shaft of the 2-stage gearbox 204 (step 308). The brake system may be designed to continuously control the brake torque to minimize the aforementioned torque imbalance during the low voltage event. In one embodiment, the brake 206 may be applied with a force that is proportional to the voltage of the power grid 224 (e.g., measured by the grid measurement unit 226). Additionally, the brake 206 may be applied with a force that is dependent upon a speed or acceleration characteristic of the wind rotor 202.

To further limit the acceleration of the wind rotor 202 caused by the guide vane 624 adjustment (step 306), the blade angles or pitch of the blades 201 of the wind rotor 202 may be adjusted (step 310). This has the effect of decreasing the torque of the blades 201 (e.g., reducing the torque the wind exerts on the rotor blades 201), thereby reducing the input energy from the wind to the wind turbine 200, which reduces the acceleration of the shaft of the wind rotor 202.

During the low voltage event, various components of the wind turbine 200 also may be isolated from the event by the turbine control system module 236 to reduce the potential of harm to such various components. For example, the yaw drives 232 and any hydraulic pumps may be isolated to prevent uncontrolled motor trip conditions that may otherwise be caused by the low voltage event (step 312).

FIG. 5 is a flow diagram 400 of one embodiment of a process or protocol for returning the wind turbine 200 to normal operation following a low voltage event. Again, this discussion may refer to certain components of the wind turbine 200 of FIGS. 2 and 3A-3D. The functionality embodied by the flow diagram 400 may be implemented by the wind turbine 200 in any appropriate manner (e.g., utilizing one or both of the control system modules 236, 228).

Initially for the case of the flow diagram 400, the wind turbine 200 may detect that the voltage level of the grid 224 is at an acceptable level (e.g., greater than 70% of the rated voltage) (step 402). Then, steps may be taken to return the wind turbine 200 to its normal operating state. Similar to the steps shown and described in FIG. 4, the steps of FIG. 5 may be performed in any sequential order, or concurrently with each other.

At step 404, the AVR 216 of the wind turbine 200 may be controlled to reduce the exciter current in the rotor winding of the synchronous generator 214 from its boosted level to a nominal level. Further, the position of the guide vanes 624 of the TRG 210 may be resumed or returned to their normal operating position (step 406). To release the limit on the acceleration of the wind rotor 202, the mechanical brake 206 may be disengaged (step 408), and the blade angles of the rotor blades 201 may be restored to their normal operation (step 410). Additionally, the electrical peripherals that were isolated in step 312 of FIG. 4 may be returned to their normal operating conditions (step 412).

FIG. 6 is timing diagram 500 that illustrates various graphs associated with the wind turbine 200 during the LVRT process described above. Initially, the representation for each graph is described. The graph 502 represents the voltage at the stator of the synchronous generator 214 as a percentage of the rated voltage. The graph 504 represents a “low voltage detect” signal that is asserted when the wind turbine 200 detects a low voltage event. The graph 506 represents the exciter current (per unit) that is applied to the rotor winding of the synchronous generator 214. The graph 508 represents the current (per unit) at the stator of the synchronous generator 214. The graph 510 represents the position (per unit) of the guide vanes 624 of the TRG 210. The graph 512 represents the force (per unit) applied to the mechanical brake 206. The graph 514 represents the blade angle in degrees of the rotor blades 201. Finally, the graph 516 represents the drive train speed (per unit).

As shown in the graph 502, the low voltage event occurs at time to, causing the stator voltage to fall to 15% of the rated voltage. As a result, the wind turbine 200 asserts the “low voltage detect” signal, as shown in graph 504. Once the “low voltage detect” signal has been asserted, the wind turbine control system module 236 may activate the various processes described above with reference to FIG. 4. More specifically, the exciter current may be boosted (graph 506), the position of the guide vanes 624 may be adjusted (graph 510), the mechanical brake 206 may be applied (graph 512), and the blade angles of the blades 201 of the wind rotor 202 may be adjusted (graph 514), or any combination thereof.

The graph 516 illustrates the speed of the mechanical drive train during the low voltage event. As shown, the drive train speed increases almost immediately after the low voltage event due to the excess mechanical torque caused by the movement of the guide vanes 624 of the TRG 210 (see step 306 shown in FIG. 4). Then, as the brake 206 and the blade angles are adjusted, the speed of the drive train is reduced through the end of the low voltage event, which occurs at time t3. After the voltage at the power grid 224 has been restored, the control system modules 228 and 236 control the operation of the wind turbine 200 to restore the drive train speed back to a nominal speed, as indicated by the arrow 520 shown in the graph 516.

As shown in the graph 508, the stator current of the synchronous generator 214 rises rapidly at the onset of the low voltage event. This occurs because the large sudden voltage drop causes a large short-circuit torque in the air-gap of the synchronous generator 214. This air-gap torque may be limited naturally by the torsional stiffness of the shaft, and also by the friction clutch 212 disposed between the synchronous generator 214 and the TRG 210.

At time t₃, the wind turbine 200 detects that the voltage has recovered to an acceptable level (e.g., 70% of rated voltage), and the turbine control system module 236 may then execute steps to return the wind turbine 200 to a normal operating state (see FIG. 5). As shown in the graph 510, the blade angles may be returned to their operating position (see the arrow 518). In one embodiment, the blade angles are adjusted at a rate that is programmable and defined by the speed-torque characteristics of the wind turbine 200. Similarly, the excitation current, the brake 206, and the blade angles of the wind rotor 202 may be restored to their normal operating conditions, as shown in the graphs 506, 512, and 514, respectively.

In addition to the aforementioned techniques, the synchronous generator 214 itself may be designed and configured to increase the LVRT capabilities of the wind turbine 200. For example, in one embodiment, the dynamic pull-out torque is maximized by providing a synchronous generator 214 with a relatively low sub-transient reactance and a low d-axis open circuit transient time constant. In this regard, the synchronous generator 214 may be capable of remaining connected to the power grid 224 when the unbalance of mechanical and electrical torque is relatively high.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

1. An automated method for allowing a wind turbine to remain electrically connected to a power grid during a low voltage event, the wind turbine comprising a synchronous generator coupled to the power grid and to a turbine rotor through a torque regulator, the method comprising:
detecting a low voltage event; and
boosting a rotor current of the synchronous generator to provide reactive power to the power grid during the low voltage event, wherein the boosting step is initiated in response to the detecting step.

2. The method of claim 1, further comprising:
adjusting a torque conversion characteristic of the torque regulator to reduce a mechanical torque applied to a shaft of the synchronous generator, wherein the adjusting a torque conversion characteristic step is initiated in response to the detecting step.

3. The method of claim 1, wherein the torque regulator comprises a torque-regulating gearbox, that in turn comprises a hydraulic circuit, the method further comprising:
reducing a mass flow of hydraulic fluid through the hydraulic circuit, wherein the reducing a mass flow step is initiated in response to the detecting step.

4. The method of claim 1, wherein the torque regulator comprises a torque-regulating gearbox, that in turn comprises a plurality of guide vanes disposed in a guide vanes housing, the method further comprising:
adjusting a position of the plurality of guide vanes, wherein the adjusting a position step is initiated in response to the detecting step.

5. The method of claim 1, wherein the torque regulator comprises a torque-regulating gearbox (TRG), the method further comprising:
adjusting an amount of energy absorbed by the TRG, wherein the adjusting an amount of energy step is initiated in response to the detecting step.

6. The method of claim 1, further comprising:
applying a brake disposed in a drive train between the turbine rotor and the torque regulator to reduce a rotational speed of the turbine rotor, wherein the applying a brake step is initiated in response to the detecting step.

7. The method of claim 6, wherein the applying a brake step is controlled dependent upon a characteristic of a voltage of the power grid.

8. The method of claim 6, wherein the applying a brake step is controlled to be proportional to a voltage of the power grid.

9. The method of claim 1, further comprising:
adjusting a blade pitch of a plurality of blades of the wind turbine to reduce a rotational speed of the turbine rotor, wherein the adjusting a blade pitch step is initiated in response to the detecting step.

10. The method of claim 1, further comprising:
isolating one or more electrical peripherals associated with the wind turbine from the power grid during the low voltage event, wherein the isolating step is initiated in response to the detecting step.

11. The method of claim 1, further comprising:
providing an uninterruptable power supply (UPS) operative to provide power to one or more components of the wind turbine during the low voltage event.

12. The method of claim 11, wherein the UPS is selected from the group consisting of at least one battery power supply, a photovoltaic cell, a capacitor, a flywheel, and any combination thereof.

13. The method of claim 1, wherein the synchronous generator is configured to have a relatively high dynamic pull-out torque.

14. The method of claim 1, wherein the synchronous generator is configured to have a d-axis synchronous reactance of less than about 1.4 p.u.

15. The method of claim 1, wherein the synchronous generator is configured to have a relatively low sub-transient reactance and relatively low d-axis open circuit transient time constant.

16. The method of claim 1, wherein the synchronous generator is configured to have a sub-transient reactance of less than about 0.15 p.u. and a d-axis open circuit transient time constant of less than about 3 p.u.

17. The method of claim 1, further comprising:
determining that a voltage of the power grid has returned to a predetermined level following the low voltage event; and
resuming normal operation of the wind turbine.

18. A wind turbine that may remain electrically connected to a power grid during a low voltage event, the wind turbine comprising:
a synchronous generator;
a torque regulator coupled to the synchronous generator;
a turbine rotor coupled to the torque regulator and comprising a plurality of turbine blades; and
a controller operative to detect an occurrence of a low voltage event and, in response to detecting the low voltage event, to cause a boost in a rotor current of the synchronous generator to provide reactive power to the power arid during the low voltage event.

19. The wind turbine of claim 18, wherein the torque regulator comprises a torque-regulating gearbox (TRG), that in turn comprises a plurality of guide vanes operative to modify a torque conversion between the turbine rotor and the synchronous generator, and wherein the controller is operative to adjust a position of the plurality of guide vanes in response to the low voltage event to reduce a mechanical torque applied to the synchronous generator.

20. The wind turbine of claim 19, wherein the TRG comprises a hydraulic circuit, and wherein the plurality of guide vanes are disposed in the hydraulic circuit.

21. The wind turbine of claim 18, wherein the torque regulator comprises a torque-regulating gearbox (TRG), and wherein the controller is operative to adjust an amount of energy absorbed by the TRG.

22. The wind turbine claim 18, further comprising:
a brake associated with a drive train extending between the turbine rotor and the torque regulator, wherein the controller is operative to apply the brake in response to the low voltage event to reduce a rotational speed of the turbine rotor.

23. The wind turbine of claim 22, wherein the controller is operative to selectively apply the brake dependent upon a characteristic of a voltage of the power grid.

24. The wind turbine of claim 22, wherein the controller is operative to selectively apply the brake dependent upon and proportional to a dip in a voltage of the power grid.

25. The wind turbine of claim 18, wherein the controller is further operative to adjust a blade pitch of the plurality of turbine blades in response to the low voltage event to reduce a rotational speed of the turbine rotor.

26. The wind turbine of claim 18, further comprising:
one or more electrical peripherals selected from the group consisting of a yaw drive, a hydraulic pump, and an electric motor;
wherein the controller is further operative to isolate the one or more electrical peripherals from the power grid during the low voltage event.

27. The wind turbine of claim 18, further comprising:
an uninterruptable power supply (UPS) operative to provide power to one or more components of the wind turbine during the low voltage event.

28. The wind turbine of claim 27, wherein the UPS is selected from the group consisting of at least one battery power supply, a photovoltaic cell, a capacitor, a flywheel, and any combination thereof.

29. The wind turbine of claim 18, wherein the synchronous generator is configured to have a relatively high dynamic pull-out torque.

30. The wind turbine of claim 18, wherein the synchronous generator is configured to have a d-axis synchronous reactance of less than about 1.4 p.u.

31. The wind turbine of claim 18, wherein the synchronous generator is configured to have a relatively low sub-transient reactance and relatively low d-axis open circuit transient time constant.

32. The wind turbine of claim 18, wherein the synchronous generator is configured to have a sub-transient reactance of less than about 0.15 p.u. and a d-axis open circuit transient time constant of less than about 3 p.u.

33. The wind turbine of claim 18, wherein the controller is further operative to determine that a voltage of the power grid has returned to a predetermined level following the low voltage event, and to resume normal operation of the wind turbine.

34. An automated method for allowing a wind turbine to remain electrically connected to a power grid during a low voltage event, the wind turbine comprising a synchronous generator coupled to the power grid and to a turbine rotor through a torque regulator, the method comprising:
detecting a low voltage event;
boosting a rotor current of the synchronous generator in response to the detecting step and to provide reactive power to the power grid during the low voltage event;
adjusting a torque conversion characteristic of the torque regulator in response to the detecting step and to reduce a mechanical torque applied to a shaft of the synchronous generator;
adjusting a blade pitch of a plurality of blades of the wind turbine in response to the detecting step and to reduce a rotational speed of the turbine rotor;
applying a brake disposed between the turbine rotor and the torque regulator in response to the detecting step and to reduce a rotational speed of the turbine rotor;
isolating one or more electrical peripherals associated with the wind turbine from the power grid in response to the detecting step;
providing an uninterruptable power supply (UPS) operative to provide power to one or more components of the wind turbine during the low voltage event;
determining that a voltage of the power grid has returned to a predetermined level following the low voltage event; and
resuming normal operation of the wind turbine.

35. The method of claim 34, wherein the torque regulator comprises a torque-regulating gearbox, that in turn comprises a hydraulic circuit, and wherein the adjusting a torque conversion characteristic step comprises:
reducing a mass flow of hydraulic fluid through the hydraulic circuit.

36. The method of claim 34, wherein the torque regulator comprises a torque-regulating gearbox, that in turn comprises a plurality of guide vanes disposed in a guide vanes housing, and wherein the adjusting a torque conversion characteristic step comprises:
adjusting a position of the plurality of guide vanes.

37. The method of claim 34, wherein the torque regulator comprises a regulating gearbox (TRG), and wherein the adjusting a torque conversion characteristic step comprises: adjusting an amount of energy absorbed by the TRG.

38. The method of claim 34, wherein the applying a brake step is controlled dependent upon a characteristic of a voltage of the power grid.

39. The method of claim 34, wherein the applying a brake step is controlled to be proportional to a voltage of the power grid.

40. The method of claim 34, wherein the UPS is selected from the group consisting of at least one battery power supply, a photovoltaic cell, a capacitor, a flywheel, and any combination thereof.

41. The method of claim 34, wherein the synchronous generator is configured to have a relatively high dynamic pull-out torque.

42. The method of claim 34, wherein the synchronous generator is configured to have a d-axis synchronous reactance of less than about 1.4 p.u.

43. The method of claim 34, wherein the synchronous generator is configured to have a relatively low sub-transient reactance and relatively low d-axis open circuit transient time constant.

44. The method of claim 34, wherein the synchronous generator is configured to have a sub-transient reactance of less than about 0.15 p.u. and a d-axis open circuit transient time constant of less than about 3 p.u.

45. An automated method for allowing a wind turbine to remain electrically connected to a power grid during a low voltage event, the wind turbine comprising a synchronous generator coupled to the power grid and to a turbine rotor through a torque regulator, the method comprising:
detecting a low voltage event;
initiating a first action in response to the detecting step, wherein the first action comprises
executing at least one step selected from the group consisting of: a) boosting a rotor current of the synchronous generator to provide reactive power to the power grid during the low voltage event; and b) adjusting a torque conversion characteristic of the torque regulator to reduce a mechanical torque applied to a shaft of the synchronous generator; and
initiating a second action in response to the detecting step, wherein the second action comprises
executing at least one step selected from the group consisting of: a) applying a brake disposed in a drive train between the turbine rotor and the torque regulator to reduce a rotational speed of the turbine rotor; and b) adjusting a blade pitch of a plurality of blades of the wind turbine to reduce a rotational speed of the turbine rotor.

46. An automated method for allowing a wind turbine to remain electrically connected to a power grid during a low voltage event, the wind turbine comprising a synchronous generator coupled to the power grid and to a turbine rotor through a torque regulator, the method comprising:
detecting a low voltage event; and
adjusting operation of the torque regulator, wherein the adjusting operation step is initiated in response to the detecting step.

47. The method of claim 46, wherein the adjusting operation step comprises adjusting a torque conversion characteristic of the torque regulator.

48. The method of claim 46, wherein the adjusting operation step comprises reducing a mechanical torque applied to a shaft of the synchronous generator.

49. The method of claim 46, wherein the torque regulator comprises a torque-regulating gearbox, that in turn comprises a hydraulic circuit, and wherein the adjusting operation step comprises:
reducing a mass flow of hydraulic fluid through the hydraulic circuit.

50. The method of claim 46, wherein the torque regulator comprises a torque-regulating gearbox, that in turn comprises a plurality of guide vanes disposed in a guide vanes housing, and wherein the adjusting operation step comprises:
adjusting a position of the plurality of guide vanes.

51. The method of claim 46, wherein the torque regulator comprises a torque-regulating gearbox (TRG), and wherein the adjusting operation step comprises:
adjusting an amount of energy absorbed by the TRG.

52. The method of any of claims 16 51 claim 46, further comprising:
applying a brake disposed in a drive train between the turbine rotor and the torque regulator to reduce a rotational speed of the turbine rotor, wherein the applying a brake step is initiated in response to the detecting step.

53. The method of claim 52, wherein the applying a brake step is controlled dependent upon a characteristic of a voltage of the power grid.

54. The method of claim 52, wherein the applying a brake step is controlled to be proportional to a voltage of the power grid.

55. The method of claim 46, further comprising:
adjusting a blade pitch of a plurality of blades of the wind turbine to reduce a rotational speed of the turbine rotor, wherein the adjusting a blade pitch step is initiated in response to the detecting step.

56. The method of claim 46, further comprising:
isolating one or more electrical peripherals associated with the wind turbine from the power grid during the low voltage event.

57. The method of claim 46, further comprising:
providing an uninterruptable power supply (UPS) operative to provide power to one or more components of the wind turbine during the low voltage event.

58. The method of claim 57, wherein the UPS is selected from the group consisting of at least one of battery power supply a photovoltaic cell, a capacitor, a flywheel, and any combination thereof.

59. The method of claim 46, wherein the synchronous generator is configured to have a relatively high dynamic pull-out torque.

60. The method of claim 46, wherein the synchronous generator is configured to have a d-axis synchronous reactance of less than about 1.4 p.u.

61. The method of claim 46, wherein the synchronous generator is configured to have a relatively low sub-transient reactance and relatively low d-axis open circuit transient time constant.

62. The method of claim 46, wherein the synchronous generator is configured to have a sub-transient reactance of less than about 0.15 p.u. and a d-axis open circuit transient time constant of less than about 3 p.u.

63. The method of claim 46, further comprising:
boosting a rotor current of the synchronous generator to provide reactive power to the power grid during the low voltage event, wherein the boosting step is initiated in response to the detecting step.

64. The method of claim 46, further comprising:
determining that a voltage of the power grid has returned to a predetermined level following the low voltage event; and
resuming normal operation of the wind turbine.

65. A wind turbine that may remain electrically connected to a power grid during a low voltage event. the wind turbine comprising:
a synchronous generator;
a torque regulator coupled to the synchronous generator;
a turbine rotor coupled to the torque regulator and comprising a plurality of turbine blades; and
a controller operative to detect an occurrence of a low voltage event and, in response to detecting the low voltage event, to adjust operation of the torque regulator.

66. The wind turbine of claim 65, wherein the torque regulator comprises a torque
regulating gearbox (TRG), that in turn comprises a plurality of guide vanes operative to modify a torque conversion between the turbine rotor and the synchronous generator, and wherein the controller is operative to adjust a position of the plurality of guide vanes in response to the low voltage event to reduce a mechanical torque applied to the synchronous generator.

67. The wind turbine of claim 66, wherein the TRG comprises a hydraulic circuit, and wherein the plurality of guide vanes are disposed in the hydraulic circuit.

68. The wind turbine of claim 65, wherein the torque regulator comprises a variable speed torque-regulating gearbox (TRG), wherein the controller is operative to adjust an amount of energy absorbed by the TRG.

69. The wind turbine claim 65, further comprising:
a brake disposed in a drive train between the turbine rotor and the torque regulator, wherein the controller is operative to apply the brake in response to the low voltage event to reduce a rotational speed of the turbine rotor.

70. The wind turbine of claim 69, wherein the controller is operative to selectively apply the brake dependent upon a characteristic of a voltage of the power grid.

71. The wind turbine of claim 69, wherein the controller is operative to selectively apply the brake dependent upon and proportional to a voltage of the power grid.

72. The wind turbine of claim 65, wherein the controller is further operative to adjust a blade pitch of the plurality of turbine blades in response to the low voltage event to reduce a rotational speed of the turbine rotor.

73. The wind turbine of claim 65, further comprising:
one or more electrical peripherals selected from the group consisting of a yaw drive, a hydraulic pump, and an electric motor;
wherein the controller is further operative to isolate the one or more electrical peripherals from the power grid during the low voltage event.

74. The wind turbine of claim 65, further comprising:
an uninterruptable power supply (UPS) operative to provide power to one or more components of the wind turbine during the low voltage event.

75. The wind turbine of claim 74, wherein the UPS is selected from the group consisting of at least one battery power supply, a photovoltaic cell, a capacitor, a flywheel, and any combination thereof.

76. The wind turbine of claim 65, wherein the synchronous generator is configured to have a relatively high dynamic pull-out torque.

77. The wind turbine of claim 65, wherein the synchronous generator is configured to have a d-axis synchronous reactance of less than about 1.4 p.u.

78. The wind turbine of claim 65, wherein the synchronous generator is configured to have a relatively low sub-transient reactance and relatively low d-axis open circuit transient time constant.

79. The wind turbine of claim 65, wherein the synchronous generator is configured to have a sub-transient reactance of less than about 0.15 p.u. and a d-axis open circuit transient time constant of less than about 3 p.u.

80. The wind turbine of claim 65, wherein the controller is operative to cause a boost in a rotor current of the synchronous generator to provide reactive power to the power grid during the low voltage event.

81. The wind turbine of claim 65, wherein the controller is further operative to determine that a voltage of the power grid has returned to a predetermined level following the low voltage event, and to resume normal operation of the wind turbine.
